(19) United States
(12) Patent Application Publication
(10) Pub. No.: US 2008/0158345 A1
(43) Pub. Date: Jul. 3, 2008

(54) 3D AUGMENTATION OF TRADITIONAL PHOTOGRAPHY

(75) Inventors: Steven J. SCHKLAIR, South Pasadena, CA (US); Bernard J. BUTLER-SMITH, Los Angeles, CA (US)

Correspondence Address: SHELDON MAK ROSE & ANDERSON PC, 100 Corson Street, Third Floor, PASADENA, CA, 91103-3842, US

(73) Assignee: 3ALITY DIGITAL SYSTEMS, LLC, Burbank, CA (US)

(21) Appl. No.: 11/853,602

(22) Filed: Sep. 11, 2007

Related U.S. Application Data
(60) Provisional application No. 60/843,421, filed on Sep. 11, 2006.

(51) Int. Cl. H04N 13/02

(52) U.S. Cl. 348/47; 348/E13.074

(57) ABSTRACT

A system for augmenting 2D image data to produce 3D imagery is disclosed comprising a primary camera for gathering the 2D image data and a pair of left and right auxiliary cameras associated with the primary camera, capable of gathering 3D information relative to the 2D image data from the primary camera. A storage device for storing the 3D information is provided, as well as optional security control module connected to the storage device for managed access to the 3D information and an image processor capable of rendering 3D imagery from the 2D image data and 3D information. The system may be used to produce 3D imagery of a complete field of view of an event of interest.

### CROSS REFERENCE TO RELATED APPLICATION

This application claims the benefit of U.S. Provisional Application Ser. No. 60/843,421 filed Sep. 11, 2006, titled “3D Augmentation of Traditional Photography,” which is hereby incorporated by reference.

### FIELD OF THE INVENTION

The present invention relates to the collection and processing of two-dimensional (2D) and three-dimensional (3D) images and data so they may be used to produced 3D images such as stereoscopic 3D images.

### BACKGROUND OF THE INVENTION

In the past century, the creation of 3D images and movies has evolved from a novelty to a powerful media for applications ranging from entertainment to homeland defense. Unfortunately the impression remains that acquiring 3D images, especially 3D movies, is time-consuming, overly complicating to production schedule, and expensive. The cost and complexity concerns have presented a significant obstacle to the growth of 3D entertainment in particular, even as 3D images and movies receive new and considerable demand by consumers. Although it is possible to approximate a 3D motion picture using image processing of a single 2D camera's images, these after-processing techniques are costly and time consuming as valuable depth information is not available and must be inferred.

Also, although simple depth map cameras are known in the art, these cameras suffer from data loss due to occlusion; if either of two cameras used to general a stereo pair doesn't capture a surface, nothing is known about its position in 3D. Complete 3D renderings of a live event require expensive motion capture equipment in controlled environment, that are unsuitable for live events such as outdoor stadium sports. Moreover, live event content is often broadcast and viewed by viewers in real-time.

Many users of cameras, especially in the live-event and motion picture industries, are not savvy to the capture or use of stereoscopic 3D imagery and perceive 3D photography as risky, costly and overtly impacting limited resources such as highly-paid actors or expensive locations. Although recent consumer demand exists for stereoscopic 3D products, stakeholders in the creation of movies in particular and other photographic means are slow to adopt cameras specifically made for the creation of stereoscopic 3D, and cling to tried and traditional equipment such as cameras.

In light of the demand for stereoscopic 3D images through outlets such as Imax 3D™, photographers' work may need to be recreated in stereo. Expensive and time-consuming image processing has some limited ability to infer 3D data (i.e., depth maps or 3D polygonal meshes) that may be used to render the existing 2D image in pseudo-stereographic 3D. One example of this approach has been to create a “virtual” second camera by using frame-by-frame context later used to re-render 2D movies frames in 3D typified by In-Three's Dimensionalization® technology. Although useful for creating 3D images of pre-existing photography, extrapolating the 3D information frame by frame takes great effort simply because the needed depth information was never captured when the original images were made.

What is needed is a method and system for capturing data for producing a 3D image which makes use of existing investment in 2D camera and video equipment, while permitting either contemporaneous production of 3D images, or storage of the 3D data so that 3D images may be rendered at a later time.

### SUMMARY OF THE INVENTION

The invention discloses a system and method to capture 3D information using a plurality of cameras auxiliary to a traditional 2D still or motion picture camera and coupled to an image processor. The image processor can also generate useful data products based on the stereopsis of the auxiliary camera images, such as disparity maps, depth maps or a polygonal mesh. The desired 3D information may be used to render the 2D imagery as 3D images at a later time, or in real-time, using image processing. The additional data to be used in creating the 3D image output may be save as images, or processed in real-time or post-processor and record by a data recording device. In addition, by recording with several groups of auxiliary cameras each group having a different point of view, the 3D image capture may be accomplished with high spatial resolution, less optical occlusion, and without additional complexity of 3D-specific requirements on the operation of the traditional 2D camera.

A plurality of auxiliary cameras are functionally interconnected with one or more primary camera(s) so that the primary camera(s) capture traditional 2D imagery such as motion picture footage. The auxiliary cameras may be operated without impact on the primary camera's user, so stereoscopic 3D information may be generated at the time of photography or later.

The primary camera may be a film camera or a digital camera. In the case of a film-based primary camera, the images may be later digitized for after-processing by an image processor. Two or more auxiliary camera images may be combined by an image processor to stereoscopically create disparity maps, depth maps or polygonal mesh date for storage and later use, or generated in real-time to be used, for example, to create a 3D broadcast of a live event.

Metadata information about the activity of the primary camera such as x-y-z position, pan, tilt, lens position and whether images are presently being collected are used to coordinate the actions of the auxiliary cameras and image processor so stereographic information may be generated. The metadata may also be stored with a storage device. The storage device and the data it contains may be secured, such as by digital encryption, so it is unavailable to the operator of the primary camera without the intercession of another party.

### BRIEF DESCRIPTION OF THE DRAWINGS

FIG. 1 shows a block diagram detailing the steps of one method of capturing 3D data of a scene to augment a 2D primary camera.

FIG. 2 shows an embodiment of the invention wherein a single 2D camera is augmented so 3D imagery may be generated at a later point in time as desired. A security control controls access to date derived from the auxiliary cameras, for example, in the case that the primary and auxiliary cameras are owned or have rights different from one another.

FIG. 3 shows an embodiment of the invention used to capture a live event where the capture of 3D data is such that there is a reduction or elimination of occlusion due to a plurality of points of view.

FIG. 4 shows another embodiment of the invention used to capture a live event.

### DETAILED DESCRIPTION OF THE INVENTION

A simpler approach to creating these 3D images after the fact has been realized in the invention by operatively coupling two or more auxiliary cameras to a primary camera. By positioning the two auxiliary cameras with appropriate interocular or baseline distance, convergence/divergence angles and other stereographic parameters it is possible to generate the difficult-to-compute depth information and store it for future use.

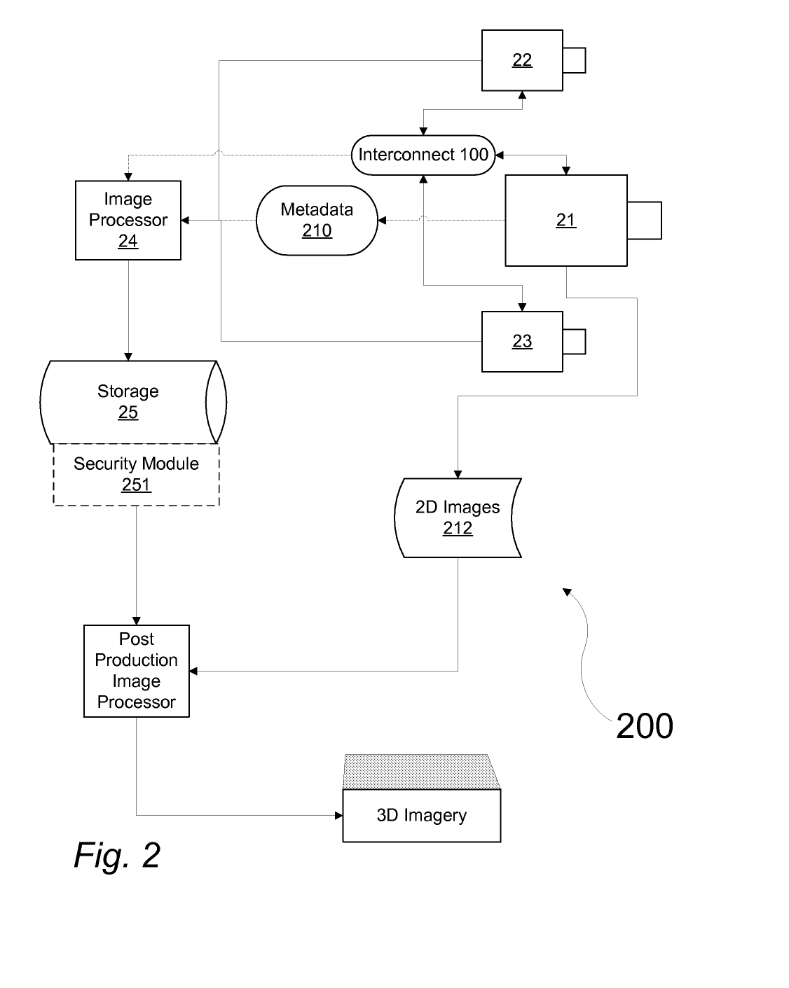

In one embodiment of the system 200 of the invention (see FIG. 2) a simple pair of left auxiliary camera 22 and right auxiliary camera 23 is positioned so to create useful stereoscopic date in coordination with a primary camera 21 taking photographs or movies. The primary camera 21 may be digital, capturing image data as digital data, or it might be a film camera using photosensitive films to retain images. Where digital image processing later takes place, it may be necessary to digitize such photosensitive film using a customary process in order to digitally process the images into stereoscopic 3D images. Information about how the primary camera is gathering its images, the primary camera metadata 210, consists of various information sequitur to the primary camera images 212 themselves. Some examples of this data might include positional data, such as relative X, Y, and Z position data for the camera, look vector information, photographic parameters such as zoom, pan, iris setting, tilt, roll, or activity parameters such as whether an exposure is being taken, or what the lighting or scene parameters may be.

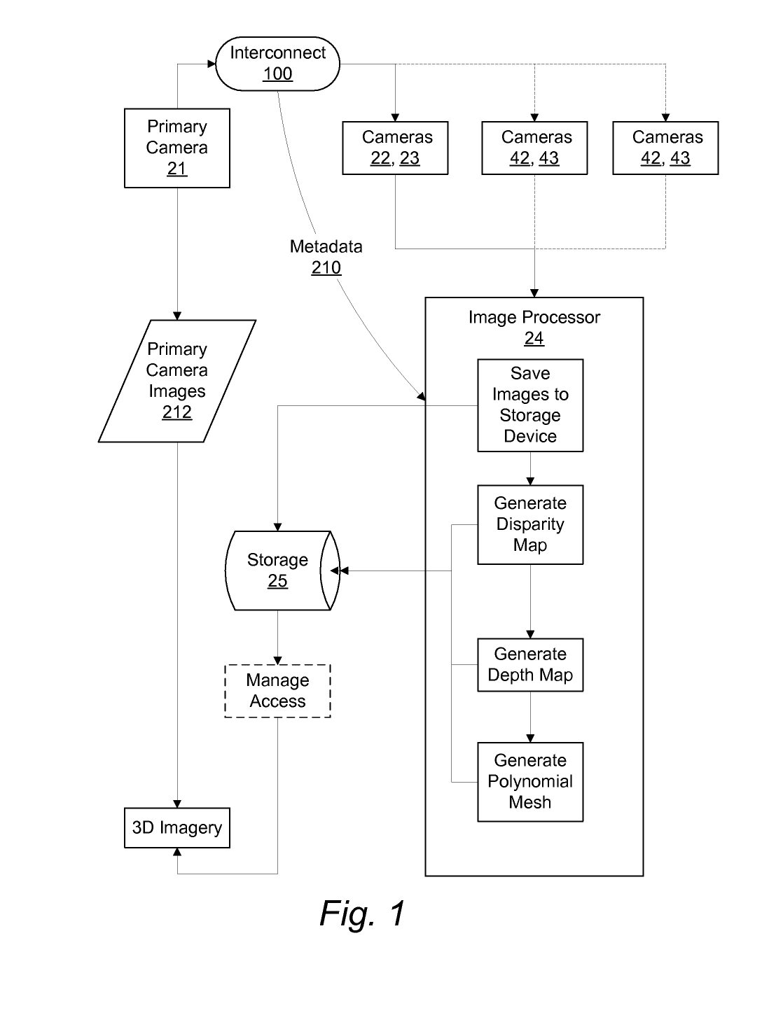

With this metadata 210, it is possible (with reference to FIG. 1) for an interconnect 100 to coordinate the activity of the auxiliary cameras 22, 23 (and optionally additional auxiliary cameras 42, 43) using a combination of hardware and/or software. Although this interconnect 100 could be quite complex and rely on the metadata 210 entirely, such as a microcontroller that adjusts the photography captured by the auxiliary cameras for convergence or inter-ocular spacing, it could be as simple as an electrical, mechanical or optical connection that signals when to stop and start collecting images between the primary and auxiliary cameras.

An image processor 24 is connected to the auxiliary cameras 22, 23 (and optionally additional auxiliary cameras 42, 43), and may receive metadata 210 from the primary camera as well. Input from an interconnect 100 that coordinates the activity of primary camera 21 and auxiliary cameras 22, 23 is also possible. When combined with the imagery from the auxiliary cameras 22, 23 and the metadata 210 from the primary camera 21, data products may be created that contain information created by stereography. For example, image processing may create disparity maps, depth maps or polygonal meshes of the surface of objects captured by the auxiliary camera images.

A disparity map composes from two distinct points of view the stereographic information necessary to define the depth position, for example, of each pixel in a digital image. It is also possible to create through other image processing a depth map on the imager positions inferred through camera metadata, such that a 3D image identifying each “pixel” as a distance from the primary camera is possible. Finally, armed with such data it is also possible to compute a skin or 3D surface defined by vertices of a polygonal surface, for example of triangles, that defines the surface of an object in 3D with respect to a single camera. After-processing of the images can be performed using software on a computer to correct, re-render, or otherwise manipulate the images of the auxiliary together with the primary camera or by themselves.

A further feature includes the information that can be computed using the primary camera 21 as yet another point of view in the image processor, as it creates stereoscopic information that may describe a scene of interest in 3D. The image processor 24 may be capable of generating the stereoscopic information with sufficient speed that the stereoscopic information may be broadcast “live,” i.e., nearly instantaneously with the collection of the auxiliary images. Many television broadcasts, for example, have a several second delay between when the live event is photographed and when the images are broadcast to the public; this “near-real time” broadcast may also be serviced by a rapidly generated stereographic information from the image processor.

It should be readily apparent to a skilled person of the art that either the images from the auxiliary cameras 22, 23, or the disparity map, depth map, or polygonal or other representative surface of the 3D object of interest may be preserved for immediate or later use in a device. A storage device 25 may be used to represent a 3D data set that helps make the primary camera's 2D imagery easier to render in 3D, or simply store the stereographic 2D images themselves for later use. In any case, the storage device 25 may use a connected security module 251 such that the data is encrypted or otherwise controlled so that access to this data is managed and may be possible only with the intercession or assent of another.

Should the 3D information be made later available based on stereoscopic information captured via the auxiliary cameras 22, 23 and their image processors and/or interconnects or metadata, it should be readily apparent to practitioners of the art that this information may be used to render a 2D image in stereoscopic 3D.

Although the image processor 24, interconnect 100 and secure storage device 251 may be physically separate, it should be readily apparent to those of skill in the art that these elements might be wholly or partly packaged together in one physical chassis of compact housing. Also, the interconnect, storage device, auxiliary and primary cameras and image processor need not be connected by wires. Wireless communications may be used to provide the required connections among the elements of the embodiment desired.

A particular differentiating feature of the invention in this embodiment is that it can output to a storage device 25, or in real-time, a series of data that are of interest in creating 3D imagery. The invention allows for any combination or permutation of direct imagery from the auxiliary cameras, disparity maps of stereoscopic difference, depth maps that illustrate the depth to object of parts of a scene of interest based on stereographic information and, potentially, primary camera metadata. Yet another product that may be generated by an image processor is a polygonal map of the surface taking into account the depth information of the scene in addition to its raster directions. Finally, the information that may define a 3D surface may take a form other than a polygonal map, such as data to define a curve as in a non-uniform Bezier spline family (i.e., NURBS data) that may describe the surface map of the scene's 3D information.

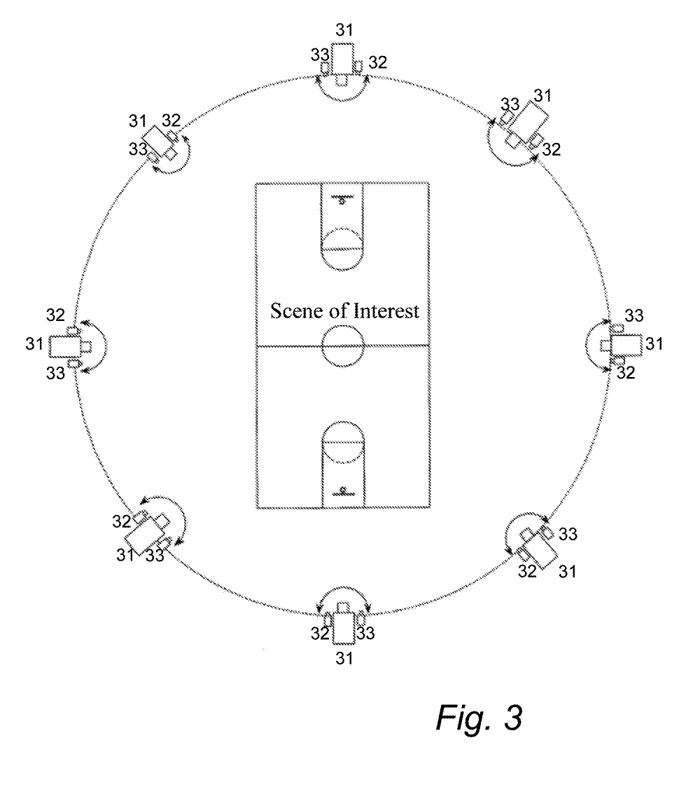

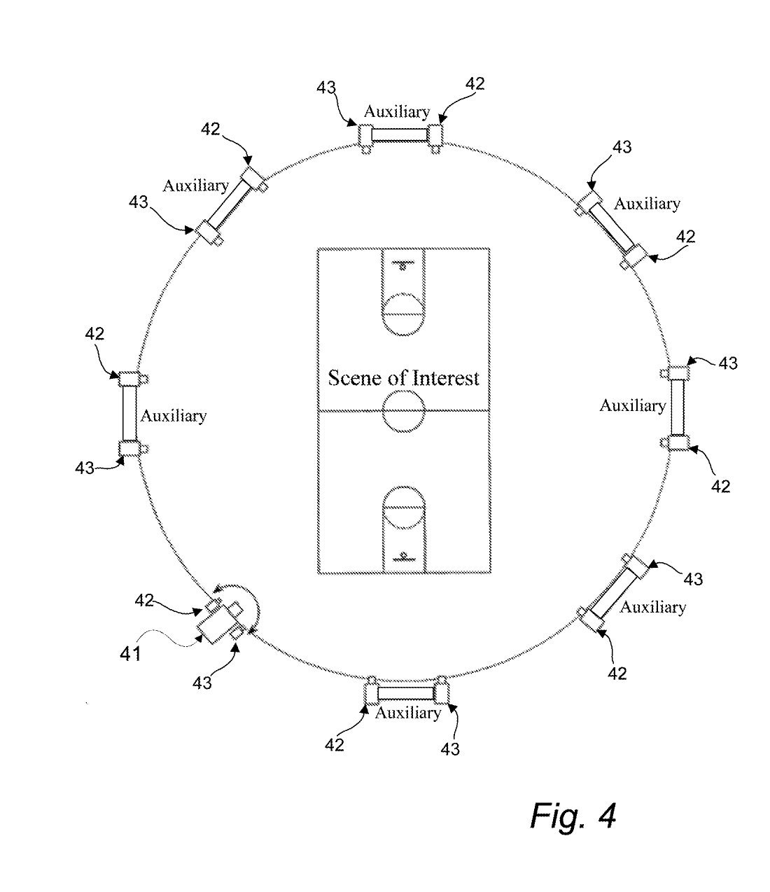

In another embodiment of the invention (FIGS. 3 and 4), an arrangement of auxiliary cameras is positioned around an event of interest, such as a live sporting event. In FIG. 3, the view angles of the cameras are such that a complete 360 degree view of an event of interest may be captured from a sufficient number of cameras to render a complete 3D map such as a polygonal mesh. It should be noted that in FIG. 3 each position has a primary camera 31, and that the interconnect 100 may coordinate the individual camera positions (i.e., a primary camera 31 and two or more auxiliary cameras 32, 33) or it may coordinate all cameras used to produce the 3D imagery. Such a configuration may allow a live event to be broadcast in real-time in stereoscopic 3D. Furthermore, though FIGS. 3 and 4 show the cameras arranged in a circle, any arrangement could be used to capture 3D images from more than one point of view.

In FIG. 4, one position has a primary camera 41, the remainder of camera positions are auxiliary cameras 42, 43 coordinated by one or more interconnects 100 and one or more image processors 24, using one or more storage devices 25 or secure storage 251.

These auxiliary cameras 32, 33 may be connected with a plurality of primary cameras 31, or may be distributed around the event with only one primary camera 41 photographing the event while a plurality of auxiliary cameras 42, 43 record stereographic information from several different view angles. In this circumstance, the interconnect 100 used to coordinate the activity of the cameras may be complex and require sophisticated software or other intelligence to ensure that the imagery and stereoscopic data products meet the requirements of the photographer. With the plurality of auxiliary cameras (either 32, 33 or 42, 43) each capturing stereographic information from many different sides of the events, it is possible to create a more complete depth image of the entire scene. Although a complex interconnect may be utilized, it should also be apparent that simple fixed auxiliary cameras placed strategically around a scene of interest may also generate useful stereographic information. Using hardware image processors such as ASIC circuit chips created to process stereoscopic images for real-time usage, any point of view in the audience may be rendered. Such 3D maps created in real-time of a sporting event may also be used in the adjudication or replay of official decisions that require positional information to help determine the games' state or whether rules were obeyed. Finally, because polynomial mesh representations of the event may be generated by the image processor and fused with 2D images as well, it is possible to broadcast in stereoscopic 3D the live event as seen from any point of view in the audience.

Another embodiment of the invention includes securing the data so that it may be restricted in use from the operator or owner of the primary camera. For example, a movie studio may not yet desire to render its feature film into a 3D form due to cost or unknown demand, but could allow the stereoscopic data to facilitate such a 3D rendering to be captured at the same time as principle photography. The data from the image processor 24 and/or auxiliary cameras 22, 23, 32, 33, or 42, 43 may be encrypted or protected in such a way as to make it unavailable to the operator of the primary camera, or the owner of the rights to the traditional photographic performance. With access to the stereoscopic 3D data captured during principle photography, the process of re-rendering a 2D film into 3D stereoscopic form is improved.

Finally it should be noted that an embodiment of this invention includes the uncontrolled, real-time capture of motion information for an object of interest such as a player in a sports game or actor in a movie, or other participant in a live event, such that the information may later render a recognizable or useful representation of the object, actor or participant of the live event. This information and a 3D positional map of activity of position may enable a variety of interactive and computer-generated movie scenes or maps of activity, and position may be created.

In the foregoing specification, the invention has been described with reference to specific embodiments thereof. It will, however, be evident that various modifications and changes may be made thereto without departing from the broader spirit and scope of the invention. The specification and drawing are, accordingly, to be regarded in an illustrative rather than a restrictive sense. It should be appreciated that the present invention should not be construed as limited by such embodiments, but rather construed according to the below claims.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

This invention is not limited to particular hardware described herein, and any hardware currently existing or developed in the future that permits processing of digital images using the method disclosed can be used.

Any currently existing or future developed computer readable medium suitable for storing data can be used for storage, including, but not limited to hard drives, floppy disks, digital tape, flash cards, compact discs, and DVDs. The computer readable medium can comprise more than one device, such as two linked hard drives, in communication with a processor.

Also, any element in a claim that does not explicitly state “means for” performing a specified function or “step for” performing a specified function, should not be interpreted as a “means” or “step” clause as specified in 35 U.S.C. § 112.

It will also be understood that the term “comprises” (or it grammatical variants) as used in this specification is equivalent to the term “includes” and should not be taken as excluding the presence of other elements or features.

We claim:

1. A system for augmenting 2D image data to produce 3D imagery comprising:
a primary camera for gathering the 2D image data;
a pair of left and right auxiliary cameras associated with the primary camera, capable of gathering 3D information relative to the 2D image data from the primary camera;
a storage device for storing the 3D information;
an interconnect between the primary camera and the pair of auxiliary cameras for coordinating their actions; and
an image processor capable of rendering 3D imagery from the 2D image data and 3D information.

2. The system of claim 1, further comprising a security control module connected to the storage device for managed access to the 3D information.

3. The system of claim 2, where the managed access comprises encryption of data.

4. The system of claim 1, where the storage device is further for storing metadata from the primary camera.

5. The system of claim 1, further comprising an image processor capable of generating data products based on the stereopsis of the auxiliary camera 3D information.

6. The system of claim 5, where the data products are a depth map, a disparity map, or a polygonal mesh.

7. A method of augmenting 2D image data gathered from a primary camera with 3D information, comprising the steps of:
providing one or more pairs of left and right auxiliary cameras to be associated with the primary camera, capable of gathering 3D information relative to the 2D image data from the primary camera;
providing a storage device for storing the 3D information; and
providing means for managed access to the 3D information stored in the storage device.

8. The method of claim 7, further comprising the step of providing an interconnect for coordinating actions between the primary camera and the one or more pairs of auxiliary cameras.

9. The method of claim 7, where the managed access comprises encryption of data.

10. The method of claim 7, where the storage device is further for storing metadata from the primary camera.

11. The method of claim 7, further comprising providing instructions on a computer readable medium for programming an image processor to generate data products based on the stereopsis of the 3D information.

12. A system for augmenting 2D image data to produce 3D imagery of a complete field of view of an event of interest comprising:
a plurality of primary cameras for gathering the 2D image data, each with a field of view, arranged such that a complete field of view of the event of interest is obtained;
a pair of left and right auxiliary cameras associated with each primary camera, capable of gathering 3D information relative to the 2D image data from the associated primary camera;
an interconnect between each primary camera and the associated pair of auxiliary cameras, for coordinating their actions; and
an image processor capable of rendering 3D imagery from the 2D image data from the primary cameras and the 3D information from the auxiliary cameras.

13. The system of claim 12, further comprising a security module for managed access to the 3D information.

14. The system of claim 13, where the managed access comprises encryption of data.

15. The system of claim 12, further comprising an image processor capable of generating data products based on the stereopsis of the auxiliary camera 3D information.

16. The system of claim 15, where the data products are a depth map, a disparity map, or a polygonal mesh.

17. A system for augmenting 2D image data to produce 3D imagery of a complete field of view of an event of interest comprising:
a primary camera for gathering 2D image data;
a plurality of pairs of auxiliary cameras capable of gathering 3D information, each pair with a field of view, arranged concentric to the event of interest such that a complete field of view of the event is obtained;
an interconnect between the primary camera and the plurality of pairs of auxiliary cameras, for coordinating their actions; and
an image processor capable of rendering 3D imagery from the 2D image data from the primary camera and the 3D information from the auxiliary cameras.

18. The system of claim 17, further comprising a security module for managed access to the 3D information.

19. The system of claim 18, where the managed access comprises encryption of data.

20. The system of claim 17, further comprising an image processor capable of generating data products based on the stereopsis of the auxiliary camera 3D information.

21. The system of claim 20, where the data products are a depth map, a disparity map, or a polygonal mesh.
